(19) United States
(12) Patent Application Publication
(10) Pub. No.: US 2011/0168603 A1
(43) Pub. Date: Jul. 14, 2011

(54) PACKAGE WITH REINFORCED END ZONES AND METHOD FOR MAKING THE SAME

(75) Inventor: Niklas PETTERSSON, Sandy (SE)

(73) Assignee: Packsize LLC, Salt Lake City, UT (US)

(21) Appl. No.: 13/069,428

(22) Filed: Mar. 23, 2011

Related U.S. Application Data
(62) Division of application No. 11/909,490, filed on Sep. 24, 2007, now Pat. No. 7,951,058.

(30) Foreign Application Priority Data
Mar. 24, 2005 (SE) 0500676-2

(51) Int. Cl. B65D 81/02; B65D 5/50; B31B 3/26; B31B 1/74

(52) U.S. Cl. 206/591; 229/167; 493/122; 493/162

(57) ABSTRACT

A blank-folded box-shaped package includes a top, a bottom opposite the top, two opposite lateral walls (I) connecting the top and the bottom, two opposite ends walls (U) connecting the top and the bottom, and two opposite peripheral shock absorbing end zones (R). Each end zone (R) is defined by one of the opposite end walls and extensions of the top, bottom and two opposite lateral walls. Also, each end zone (R) defines an exposed cavity region with the end walls in a retracted position inwardly of the shock absorbing end zone (R) of doubled material. The package defines a package blank in an unfolded state.

### CROSS REFERENCE TO RELATED APPLICATIONS

This application is a new Divisional of co-pending application Ser. No. 11/909,490 filed on Sep. 24, 2007, which is the 35 U.S.C. §371 national stage of International PCT/SE06/00361 filed on Mar. 23, 2006, which claims priority to Swedish Application No. 0500676-2 filed on Mar. 24, 2005. The entire contents of each of the above-identified applications are hereby incorporated by reference.

### BACKGROUND OF THE INVENTION

The invention concerns a package having at least one reinforced end zone, and a method for making the same. The package may advantageously be formed manually from a package blank by use of a tool specifically designed for this purpose.

### DESCRIPTION OF THE RELATED ART

In the manual folding of package blanks in order to produce a box shaped package designed with a reinforced protective zone in one or both ends of the package, additional folds are required to achieve a zone of double layers of material. During the folding operation there is a need to temporarily hold the package blank in a partly folded position. A tool for this purpose must allow simple holding and release of the package blank.

A tool suitable for producing the package of the present invention preferably has means that can be activated to temporarily clamp a package blank bottom down against a work surface, and means that can be activated to support part of the package blank in a position erected from the work surface during the insertion of products into the package before the package is finally closed.

### BRIEF SUMMARY OF THE INVENTION

To this purpose, the tool may be designed with a bottom plate having a support wall or abutment erect from the front edge of the bottom plate, a tongue protruding in front of the support wall from the front edge of the bottom plate, and a jaw acting from above against the tongue, as well as a spring loaded and back-springing lip protruding in front of the support wall and retractable against the spring force in dependence of the fact that during folding a part of a package blank is made to pass by the lip, and then springs back to support the package blank in the attained folded position.

### BRIEF DESCRIPTION OF THE DRAWINGS

The invention will be described in more detail below with reference to the enclosed drawings, wherein

FIG. 1 shows a tool in a lateral elevation view;

FIG. 2 shows the tool in a top elevation view;

FIG. 3 shows the tool in a rear elevation view;

FIG. 4 shows the tool in an oblique bottom/rear perspective view;

FIG. 5 shows the tool according to the invention in an oblique top/front perspective view;

FIGS. 6a-6d show successive steps in the procedure of folding a package blank in order to prepare a package having reinforced end zones, utilizing the tool illustrated in FIGS. 1-5.

### DESCRIPTION OF THE PREFERRED EMBODIMENTS

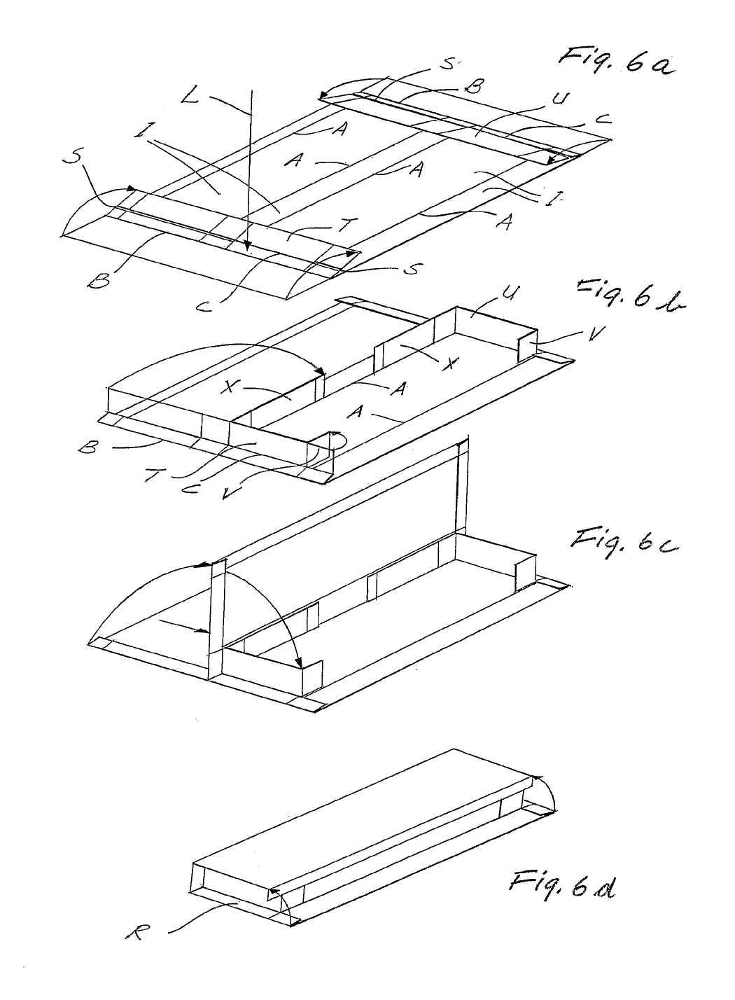

Referring to FIG. 6a, a package blank is shown wherein slits and fold lines have been introduced in a planar initial format for folding the blank into a box shaped package. Thus, the package blank comprises three or more longitudinal fold lines A defining the lateral walls I, top, and bottom of the package, the fold lines A forming the corner edges of the completed package when the package blank has been folded into a box shaped package. In at least one, preferably in both ends of the package blank, two fold lines B and C extend transversally to said first longitudinal fold lines A. The inner transverse fold line B forms an end edge of the completed package. The outer fold line C, which extends through one of the top or bottom portions of the package blank only and outside said portion transforms in slits S, forms the connection of the end wall T, U to the peripheral end zone R of doubled material that is formed by folding the blank along the fold line B. In this manner, a package having a protective zone in its end is formed, whereby the end walls obtains a retracted position inwardly of a shock absorbing end zone R made from doubled material. In order to fully understand the design of the completed package, reference is made to the series of pictures in FIGS. 6a-6d.

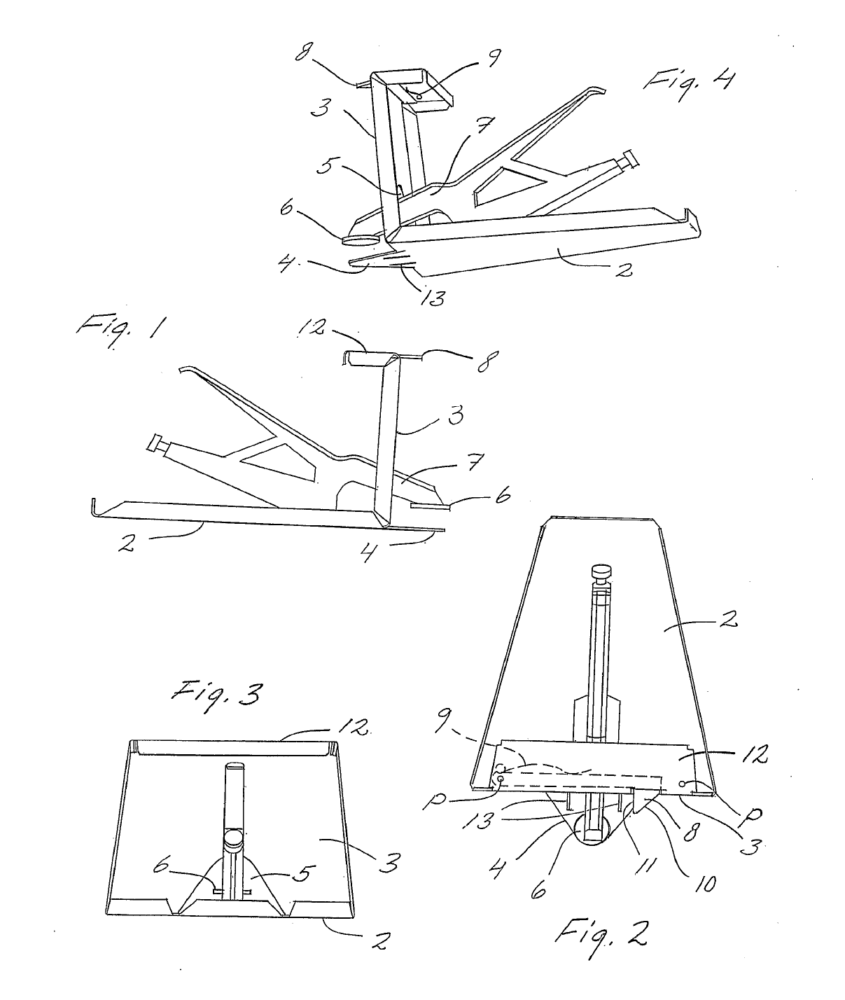

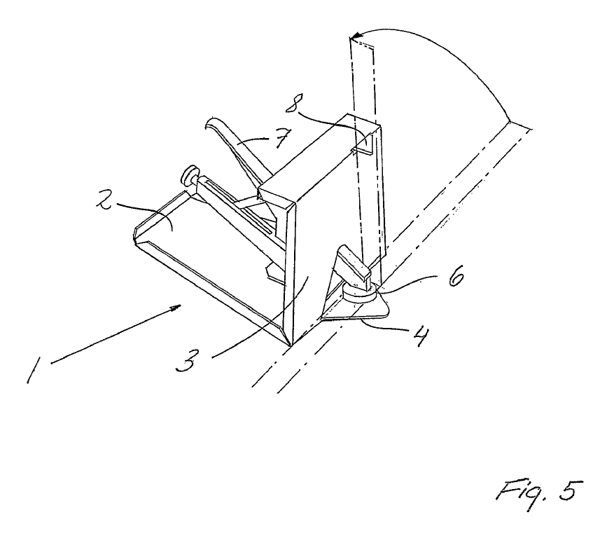

Referring to FIGS. 1-4 a tool is shown, designed for manually folding a package blank of the type described above.

The tool 1 comprises a bottom plate 2, having on one of its, henceforth considered front edges an erect abutment 3, in the embodiment shown formed as a supporting wall 3 that extends substantially vertically erected. From the front edge of the bottom plate 2 a tongue 4 projects in front of the supporting wall or abutment 3. Through an opening 5, formed in the abutment or supporting wall 3 and in the embodiment shown delimited by the front edge of the bottom plate, a jaw 6 extends through the supporting wall above the tongue. The jaw 6 is movably arranged and can be activated for temporary clamping of the protective zone of the package blank in the gap between the tongue 4 and the jaw. For this purpose, the jaw is suitably supported in the tip of a leg 7 mounted on the bottom plate and extending through the opening 5. The jaw 6 and the leg 7 may advantageously form parts of a pair of grab tongs of a welding gun mounted on the bottom plate, e.g. by welding or bolts. Preferably, the leg is provided with a release mechanism for single handed activation of a kind known per se from commercially available grab tongs, such as the grab tongs manufactured by Danish company Scangrip A/S.

A lip 8 is arranged in the support wall 3 and movable between a position protruding in front of the support wall and a position retracted inside of or into the support wall. The lip is biased to the protruding position by a spring means 9 and retractable against the action of the spring means as a function of the fact that a part of the package blank during a folding operation is made to pass the lip. The protruding part of the lip 8 is delimited on one side by an edge 10 that is tilted in relation to the support wall 3 and, in the tip of the lip, transforms into an edge 11 that is substantially perpendicular to the support wall and forms the other side of the lip 8. Since part of the package blank is erected from the support in the folding operation, by folding along a fold line A, and is made to pass substantially parallel to the supporting wall in the direction of said tilted edge, the lip is pushed away by the package blank passing the lip and then held in the erected position, supported against the perpendicularly upright edge of the lip, now springing back and protruding.

The bottom plate 2, tongue 4, and vertical supporting wall 3 of the tool can be prepared from one single piece, such as from a plate of steel, whereby the front edge of the bottom plate is made by bending in a line running between the bottom plate 2 and the supporting wall 3, and the tongue 4 is integrally formed by an opening 5 being cut out of the supporting wall. The lip 8 and the spring means 9 are suitably arranged on the underside of an upper end area 12 of the supporting wall 3, being bent backwards. In FIG. 2, a broken line illustrates the spring means 9 in the form of a torsion spring, pin spring or leaf spring 9, the spring means pre-stressing and thereby loading an arm in one end mounted pivotably at P and in the opposite end formed with the lip 8. In this connection it is to be noted that the tool shown may be arranged for simple switching between left hand position and right hand position, by alternative mounting positions P, P′ for the lip 8 and the spring 9, and double slits for penetration of the lip 8 through the support wall 3 (as illustrated in FIG. 2).

Reference is now made to FIG. 5 and FIGS. 6a-6d for the use and function of the tool.

In a first operation for the completion of a box shaped package, the package blank is folded in accordance with FIG. 6a in the inner fold line B extending transversally over the width of the package blank. The protective zone thus folded in double is inserted against the abutment or support wall 3 into the gap between the jaw 6 and the tongue 4, where after the jaw is activated to hold the protective zone of the package blank by clamping against the tongue 4 in the direction of the arrow L in FIG. 6a. In this first support position, illustrated in FIG. 5 with the package blank shown in a broken single-dot line, the package blank is held in order to facilitate the other operations during folding, such as the subsequent folds in the opposite end of the package blank.

In this connection it is to be pointed out that the jaw 6 preferably has a length protrading outside of the supporting wall and adapted to the distance between the fold lines B and C, said distance forming the height or width of the protective zone of doubled material in the end of the package. It is further advised that the tongue 4 should comprise a mark, e.g. in the form of a slit 13 in the longitudinal direction of the tongue, towards which mark a fold line A can be oriented when the package blank is inserted into the tool for supporting contact against the abutment/supporting wall 3.

In the next operation, the end walls T, U of the package are erected by folding along fold lines C. The free-cut extensions X, V of the end walls are thereafter folded inwards in the direction of the respective fold lines A which form the corners of the finished package, in the direction towards the axial center of the package blank. After that folding, the extended portions X, V of the end walls will extend supportively inside of and adjacent opposite lateral walls of the completed package. With this operation, the package blank has adopted the position shown in FIG. 6b.

Thereafter, folding along fold line A is performed to erect a first lateral wall positioned outside of the tool grip on the farthermost side of the tool, viewed from the position of the operator. This folding is performed so that the doubled rim, and more specifically that part thereof which forms an extension of the lateral wall connecting in said fold line A to the bottom portion held by the tool, during the erection operation passes the lip 8 and is thereby held temporarily in the upright position as shown in FIG. 6c. In FIG. 5, this second supported position is illustrated with the package blank shown in a double-dot broken line.

In the second supported position, in which the tool aided by the lip 8 temporarily holds the package blank in an open condition with the top portion of the package blank standing in an upright position, products can easily be put into the open package. The erected sections of the package blank, which is prevented by the lip 8 from falling back onto the work surface, in turn secures the inwardly folded extensions of the end walls T, U, whereby these, too, are locked in their erected positions. Thereby, the operator has both hands free for the insertion of products into a receiving space defined by the bottom, end walls and firstly erected lateral wall, before the package blank is closed by folding along the other fold lines A in order to form a finalized package enclosing the products.

In a final folding operation along the remaining fold lines A, the erected upright wall, referred to as the top portion in the above paragraph, is lowered and the second lateral wall (closest to the operator) is erected to close the package in accordance with FIG. 6d. The completely folded package may thereafter be detached from the tool by activating the release mechanism of the jaw.

The primary function of the tool is to form a “third hand” aiding the operator by temporarily fixing the package blank in a partly folded position while both hands of the operator are busy performing the next folding operation or filling the package with products. Therefore, the tool is preferably utilized standing freely on a work table or on a conveyor belt in a production line in order to enable the operator to handle the package blank freely for folding or insertion of products, but may alternatively be fixed on the work table, or integrated into this table by having the bottom plate fitted into the table surface or forming part of said surface. The shown embodiment of the tool is adapted for, and described as utilized in, the folding of a package blank designed to prepare a package having reinforced end zones, said package blank comprising longitudinal fold lines A along which the package blank can be folded to form the lateral walls I of the package, fold lines B, C running transverse to fold lines A and along which the package lank is foldable (B) to form a peripheral protective zone R of double-folded material at the end of the package, and foldable (C) to form the end wall T, U of the package with associated, free-cut extensions V, X, respectively. In this implementation, the tool thus comprises means 4, 6 which can be activated for engagement with the protective zone R for temporary clamping of the package blank bottom down against a work surface, as well as means 8 which can be activated in order to support a part of the package blank in a position erected from the work surface during the insertion of products into the package.

What is claimed is:

1. A package blank, comprising:
a planar format blank having slits and fold lines for folding the blank into a box shaped package,
the blank having a top portion and a bottom portion,
the fold lines including at least three longitudinal fold lines (A) for defining the lateral walls (I), a package top, and a package bottom,
wherein the longitudinal fold lines (A) form corner edges of the box shaped package when the blank has been folded into a completed package,
the fold lines further include at least two end fold lines (B, C) in an end of the blank, the end fold lines extending transversally to said longitudinal fold lines (A) along a inner transverse line and an outer transverse line,
a first of the end fold lines (B), located at the inner transverse line, operative, upon bending of the blank, to form an end edge of the completed package,
a second of the end fold lines (C), located at the outer transverse line in one of i) the top portion and ii) the bottom portion of the blank,
first and second slits (S) located at outside ends of the second transverse line,
a first of the slits located at the one of i) the top portion and ii) the bottom portion of the blank, in which the second end fold line (C) is located,
a second of the slits located at another of i) the top portion and ii) the bottom portion of the blank in which the second end fold line (C) is not located,
the first and second slits defining free cut extensions (V, X),
the first of the end fold line (B) operative, upon bending of the blank, to form a peripheral end zone (R) of doubled material,
the second of the end fold lines (C) operative, upon bending of the blank, to form a connection of two orthogonal end walls (T, U) to a peripheral shock absorbing end zone (R) of the completed package,
wherein, upon bending of the blank, the completed package includes a protective zone, whereby the end walls obtain a retracted position inwardly of the shock absorbing end zone (R) of doubled material.

2. A method of forming a package, comprising the steps of:
A) using a package blank a planar having slits and fold lines for folding the blank into a box shaped package,
the blank having a top portion and a bottom portion,
the fold lines including at least three longitudinal fold lines (A) for defining a lateral walls (I), a package top, and a package bottom,
wherein the longitudinal fold lines (A) form corner edges of the box shaped package when the blank has been folded into a completed package,
the fold lines further include at least two end fold lines (B, C) in an end of the box shaped package, the end fold lines extending transversally to said longitudinal fold lines (A) along a inner transverse line and an outer transverse line,
a first of the end fold lines (B), located at the inner transverse line, operative, upon bending of the blank, to form an end edge of the completed package,
a second of the end fold lines (C), located at the outer transverse line in one of i) the top portion and ii) the bottom portion of the blank,
first and second slits (S) located at outside ends of the second transverse line,
the first and second slits defining free cut extensions (V, X),
a first of the slits located at the one of i) the top portion and ii) the bottom portion of the blank, in which the second end fold line (C) is located,
a second of the slits located at another of i) the top portion and ii) the bottom portion of the blank in which the second end fold line (C) is not located,
the first of the end fold line (B) operative, upon bending of the blank, to form a peripheral end zone (R) of doubled material,
the second of the end fold lines (C) operative, upon bending of the blank, to form a connection of two orthogonal end walls (T, U) to a peripheral shock absorbing end zone (R) of the completed package;
B) folding the package blank along the first end fold line (B) to form the peripheral protective end zone (R);
C) fixing the package blank by releasable clamping of the formed protective zone (R) in a tool;
D) folding the package blank along the second end fold line (C) to erect the end walls (T, U) inwardly of the formed protective end zone (R);
E) folding portions the package blank associated with the first and second slits towards an axial center of the blank to locate the extensions (V, X) and to extend along a first of the longitudinal fold lines (A);
F) folding the package blank along a second of the longitudinal fold lines (A) to erect a first of the lateral walls (I);
G) by temporarily supporting the formed first lateral wall (I) in an erect position, with the first lateral wall in turn supporting the extensions (V, X), securing the end walls (T, U) in an erect position to form a receiving space delimited by the package bottom, the first lateral wall (I), and the end walls (T, U); and
H) folding the package blank along remaining longitudinal fold lines (A) to form a top and a second lateral wall (I) of the package.

3. The method of claim 2, further comprising the further steps of:
folding the package blank along another first end fold line (B) to form another peripheral protective end zone (R); and
folding further portions the package blank associated with further first and second slits towards the axial center of the blank to locate further extensions (V, X) and to extend along the first of the longitudinal fold lines (A).

4. The method of claim 2, further comprising the step of:
preparing the package blank used in step A).

5. The method of claim 4, wherein,
the second of the end fold lines (C) is located at the outer transverse line in the top portion the blank, and
a third of the end fold lines (C) is located at an end of the blank opposite the second end fold line (C) in the top portion the blank.

6. The method of claim 2, wherein,
said step H) of folding the package blank along remaining longitudinal fold lines (A) to form a top and a second lateral wall (I) of the package comprises:
H1) folding the package blank along the first longitudinal fold lines (A) to bring the top orthogonal to the bottom and define a partial double rim,
H2) folding the package along a first of the remaining longitudinal lines (A) to bring the top parallel to the bottom, and
H3) folding the package along a second of the remaining longitudinal lines (A) to the second lateral wall (I) to the top.

7. The method of claim 2, wherein,
after step H), the peripheral shock absorbing end zone (R) defines an exposed cavity region with the end wall (U) in a retracted position inwardly of the shock absorbing end zone (R) of doubled material.

8. A blank-folded box-shaped package, comprising:
a top;
a bottom opposite the top;
two opposite lateral walls (I) connecting the top and the bottom;
two opposite ends walls (U) connecting the top and the bottom; and
two opposite peripheral shock absorbing end zones (R),
each end zone (R) defined by one of the opposite end walls and extensions of the top, bottom and two opposite lateral walls,
each end zone (R) defining an exposed cavity region with the end walls in a retracted position inwardly of the shock absorbing end zone (R) of doubled material,
wherein in an unfolded state the package defines a package blank.

9. The blank-folded box-shaped package, of claim 8, wherein,
the unfolded package blank has slits and fold lines for folding the blank into the package,
the blank has a top portion and a bottom portion,
the fold lines includes at least three longitudinal fold lines (A) for defining the lateral walls (I), the top, and the bottom,
the longitudinal fold lines (A) form corner edges of the box shaped package when the blank has been folded into the package,
the fold lines further include at least two end fold lines (B, C) in each end of the blank, the end fold lines extending transversally to said longitudinal fold lines (A) along a inner transverse line and an outer transverse line,
a first of the end fold lines (B), located at the inner transverse line, operative, upon bending of the blank, to form an end edge of the package,
a second of the end fold lines (C), located at the outer transverse line in one of i) the top portion and ii) the bottom portion of the blank,
first and second slits (S) located at outside ends of the second transverse line,
a first of the slits located at the one of i) the top portion and ii) the bottom portion of the blank, in which the second end fold line (C) is located,
a second of the slits located at another of i) the top portion and ii) the bottom portion of the blank in which the second end fold line (C) is not located,
the first and second slits defining free cut extensions (V, X),
the first of the end fold line (B) operative, upon bending of the blank, to form a peripheral end zone (R) of doubled material,
the second of the end fold lines (C) operative, upon bending of the blank, to form a connection of two orthogonal end walls (T, U) to a peripheral shock absorbing end zone (R) of the package.

10. The blank-folded box-shaped package, of claim 8, wherein,
the package blank has i) longitudinal fold lines (A) along which the package blank is foldable in order to form the lateral walls (I), the top and the bottom of the package, and ii) transverse fold lines (C) extending transversally to the longitudinal fold lines (A) and along which transverse fold line the package blank is foldable in order to form the end walls (T, U), the transverse fold lines having associated, free-cut extensions (V, X), wherein in the finished package the extensions (V, X) extend towards the axial center of the package along the longitudinal fold lines (A) and are in this position effective for securing the end walls (T, U) under support from the lateral walls (I), further comprising at least one transverse fold line (B) along which the package blank is foldable in order to form a peripheral protective end zone (R) of doubled material outwardly of the end wall (T, U) in at least one end of the package.
